(19) United States
(12) Patent Application Publication
(10) Pub. No.: US 2020/0384733 A1
(43) Pub. Date: Dec. 10, 2020

(54) COMPOSITE CLADDINGS AND APPLICATIONS THEREOF

(71) Applicant: Kennametal Inc., Latrobe, PA (US)

(72) Inventors: Qingjun ZHENG, Export, PA (US); Johnny Martin, New Albany, IN (US); James Faust, New Albany, IN (US)

(21) Appl. No.: 16/431,211

(22) Filed: Jun. 4, 2019

(51) Int. Cl. B32B 15/01; B32B 15/08

(52) U.S. Cl. CPC B32B 15/01; B32B 15/08; B32B 2307/712; B32B 2307/554; B32B 2264/107

(57) ABSTRACT

In one aspect, articles are described herein comprising composite claddings which, in some embodiments, demonstrate desirable properties including thermal conductivity, transverse rupture strength, fracture toughness, wear resistance and/or erosion resistance. Briefly, an article described herein comprises a metallic substrate, and a cladding adhered to the metallic substrate, the cladding comprising at least 10 weight percent of sintered cemented carbide pellets dispersed in matrix metal or matrix alloy, the sintered cemented carbide pellets having a spherical shape, spheroidal shape, or a mixture of spherical and spheroidal shapes.

### FIELD

The present invention relates to claddings for metal and alloy substrates and, in particular, to claddings comprising a hard particle phase including spherical and/or spheroidal carbide pellets.

### BACKGROUND

Claddings are often applied to articles or components subjected to harsh environments or operating conditions in efforts to extend the useful lifetime of the articles or components. Various cladding identities and constructions are available depending on the mode of failure to be inhibited. For example, wear resistant, erosion resistant and corrosion resistant claddings have been developed for metal and alloy substrates. In the case of wear resistant and/or erosion resistant claddings, a construction of discrete hard particles dispersed in a metal or alloy matrix is often adopted. While effective in inhibiting wear and erosion in a wide variety of applications, claddings based on this construction often exhibit losses in transverse rupture strength and fracture toughness rendering the claddings prone to cracking.

### SUMMARY

In one aspect, articles are described herein comprising composite claddings which, in some embodiments, demonstrate desirable properties including thermal conductivity, transverse rupture strength, fracture toughness, wear resistance and/or erosion resistance. Briefly, an article described herein comprises a metallic substrate, and a cladding adhered to the metallic substrate, the cladding comprising at least 10 weight percent of sintered cemented carbide pellets dispersed in matrix metal or matrix alloy, the sintered cemented carbide pellets having a spherical shape, spheroidal shape, or a mixture of spherical and spheroidal shapes.

In another aspect, composite articles for producing claddings are described herein. In some embodiments, a composite article comprises a polymeric carrier, and sintered cemented carbide pellets dispersed in the polymeric carrier, the sintered cemented carbide pellets having an apparent density of 4 g/cm³ to 7.5 g/cm³, wherein the composite article has a density of 7.0-10 g/cm³. In some embodiments, the composite article further comprises powder metal or powder alloy dispersed in the polymer carrier. Further, in some embodiments, greater than 80 percent of the sintered cemented carbide pellets can have a particle size less than 105 μm or 140 mesh by sieving (ASTM B214 or laser diffraction particle size analysis, ASTM B822). Additionally, greater than 80 percent of the sintered cemented carbide pellets can have a particle size less than 74 μm or 200 mesh.

In a further aspect, methods of making cladded articles are provided. A method of making a cladded article comprises providing a metallic substrate and positioning a layer of sintered cemented carbide pellets dispersed in organic carrier over the metallic substrate, the sintered cemented carbide pellets having a spherical shape, spheroidal shape, or a mixture of spherical and spheroidal shapes. Matrix metal or matrix alloy is also positioned over the metallic substrate. In some embodiments, matrix metal or matrix alloy is dispersed in the organic carrier with the sintered cemented carbide pellets. Alternatively, the matrix metal or matrix alloy is dispersed in a separate organic carrier or is provided as a foil. The matrix metal or matrix alloy is heated to infiltrate the layer of sintered cemented carbide pellets providing a composite cladding adhered to the substrate.

These and other embodiments are further described in the following detailed description.

### BRIEF DESCRIPTION OF THE DRAWINGS

FIG. 1 is a scanning electron microscopy (SEM) image of sintered cemented carbide pellets having a mixture of spherical and spheroidal shapes according to some embodiments.

FIG. 2 is an SEM image of sintered cemented carbide particles having angular and/or faceted shapes.

FIG. 3 illustrates thermal conductivity disparities between prior claddings employing angular sintered carbides and claddings of the present disclosure comprising spherical and/or spheroidal sintered cemented carbide pellets, according to some embodiments.

FIG. 4(a) provides comparative Young's modulus data of claddings described herein with prior claddings employing angular sintered cemented carbides, according to some embodiments.

FIG. 4(b) provides comparative shear modulus data of claddings described herein with prior claddings employing angular sintered cemented carbides, according to some embodiments.

FIG. 5(a) is an image illustrating microhardness testing using a pyramid diamond indenter at 0.5 kg (HV0.5) of a spheroidal sintered cemented carbide particle of a cladding herein, according to some embodiments.

FIG. 5(b) in an image of microhardness testing using a pyramid diamond indenter at 0.5 kg (HV0.5) of an angular sintered cemented carbide pellet of a prior cladding architecture.

FIG. 5(c) illustrates the microhardness testing results wherein the angular sintered cemented carbide exhibits higher hardness relative to spheroidal sintered cemented carbide.

FIG. 6 illustrates hardness of claddings described herein comprising spherical and/or spheroidal sintered cemented carbide particles relative to prior claddings having angular sintered cemented carbide particles, according to some embodiments.

FIG. 7(a) is an optical micrograph of a cladding described herein comprising spherical and/or spheroidal sintered cemented carbide pellets according to some embodiments.

FIG. 7(b) is an optical micrograph of a cladding comprising angular and/or faceted sintered cemented carbide particles of a prior cladding architecture.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Cladded Articles

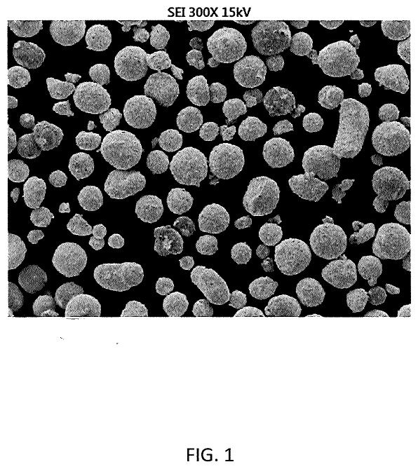

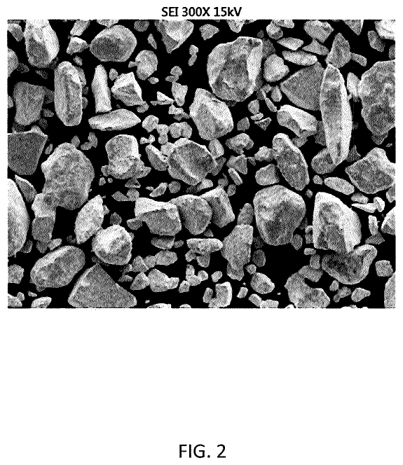

Articles described herein comprise a metallic substrate, and a cladding adhered to the metallic substrate, the cladding comprising at least 10 weight percent of sintered cemented carbide pellets dispersed in matrix metal or matrix alloy, the sintered cemented carbide pellets having a spherical shape, spheroidal shape, or a mixture of spherical and spheroidal shapes. FIG. 1 is an SEM microscopy image of sintered cemented carbide pellets having a mixture of spherical and spheroidal shapes according to some embodiments. The spherical and spheroidal nature of the sintered cemented carbide pellets is in sharp contrast to angular and faceted particles employed in prior claddings, such as those illustrated in the SEM image of FIG. 2. In some embodiments, the spherical and/or spheroidal sintered cemented carbide pellets have an aspect ratio of 0.5 to 1. The spherical and/or spheroidal sintered cemented carbide pellets may also have an aspect ratio of 0.6-1, 0.7-1 or 0.8-1, in some embodiments.

The spherical and/or spheroidal sintered cemented carbide particles of the cladding each comprise individual metal carbide grains sintered and bound together by a metallic binder phase. Individual metal carbide grains of a sintered cemented carbide particle can have any size consistent with the objectives of the present invention. In some embodiments, metal carbide gains of a sintered cemented carbide pellet generally have sizes less than 3 μm, such as 1-2 microns. Metal carbide grains of sintered cemented carbide pellet may also have sizes less than 1 μm, including less than 100 nm.

The spherical and/or spheroidal sintered cemented carbide pellets comprise metal carbide grains selected from the group consisting of Group IVB metal carbides, Group VB metal carbides, Group VIB metal carbides, and mixtures thereof. In some embodiments, tungsten carbide is the sole metal carbide of the sintered cemented carbide pellets. In other embodiments, one or more Group IVB, Group VB and/or Group VIB metal carbides are combined with tungsten carbide to provide the sintered pellets. For example, chromium carbide, titanium carbide, vanadium carbide, tantalum carbide, niobium carbide, zirconium carbide and/or hafnium carbide and/or solid solutions thereof can be combined with tungsten carbide in sintered pellet production. Tungsten carbide can generally be present in the sintered pellets in an amount of at least about 80 or 85 weight percent. In some embodiments, Group IVB, VB and/or VIB metal carbides other than tungsten carbide are present in the sintered pellets in an amount of 0.1 to 5 weight percent.

In some embodiments, the sintered cemented carbide pellets comprise double metal carbides or lower metal carbides. Double and/or lower metal carbides include, but are not limited to, eta phase (Co₃W₃C or Co₆W₆C), W₂C and/or W₃C. Additionally, the sintered cemented carbide pellets can exhibit uniform or substantially uniform microstructure.

Spherical and/or spheroidal sintered cemented carbide pellets comprise metallic binder. Metallic binder of sintered cemented carbide pellets can be selected from the group consisting of cobalt, nickel and iron and alloys thereof. In some embodiments, metallic binder is present in the sintered cemented carbide pellets in an amount of 3 to 20 weight percent. Metallic binder can also be present in the sintered cemented carbide particles in an amount selected from Table I.

TABLE I
Metallic Binder Content (wt. %)
3-15
4-13
5-12

Metallic binder of the sintered cemented carbide pellets can also comprise one or more additives, such as noble metal additives. In some embodiments, the metallic binder can comprise an additive selected from the group consisting of platinum, palladium, rhenium, rhodium and ruthenium and alloys thereof. In other embodiments, an additive to the metallic binder can comprise molybdenum, silicon or combinations thereof. Additive can be present in the metallic binder in any amount not inconsistent with the objectives of the present invention. For example, additive(s) can be present in the metallic binder in an amount of 0.1 to 10 weight percent of the sintered cemented carbide pellet.

In some embodiments, the spherical and/or spheroidal sintered cemented carbide pellets have an average individual porosity of less than 5 vol. %. Moreover, the sintered cemented carbide pellets can have an average individual particle porosity less than 2% or less than 1%, in some embodiments. Similarly, spherical and/or spheroidal sintered cemented carbide pellets can be greater than 98% or 99% percent theoretical full density. The sintered cemented carbide pellets can have any average size consistent with producing metal matrix composite claddings having desirable properties including, but not limited to, enhanced thermal conductivity, transverse rupture strength, fracture toughness, wear resistance and/or erosion resistance. Spherical and/or spheroidal sintered cemented carbide pellets of the cladding have an average size of 10 μm to 100 μm. In some embodiments, greater than 50 percent of the sintered cemented carbide pellets have size less than 45 μm.

As detailed above, spherical and/or spheroidal sintered cemented carbide pellets are present in the cladding in an amount of at least 10 weight percent. In some embodiments, sintered cemented carbide pellets are present in an amount of 20 to 80 weight percent of the cladding. Spherical and/or spheroidal sintered cemented carbide pellets can also be present in the cladding in an amount selected from Table II.

TABLE II
Amount of Sintered Cemented Carbide Pellets (wt. % of cladding)
35-75
40-70
50-75
50-65

Claddings described herein can comprise hard particles in addition to the spherical and/or spheroidal sintered cemented carbide pellets, in some embodiments. Such hard particles can comprise nitrides of aluminum, boron, silicon, titanium, zirconium, hafnium, tantalum or niobium, including cubic boron nitride, or mixtures thereof. Additionally, hard particles can comprise borides such as titanium di-boride, B₄C or tantalum borides or silicides such as MoSi₂ or Al₂O₃—SiN. Hard particles can also comprise crushed cemented carbide, crushed carbide, crushed nitride, crushed boride, crushed silicide, or combinations thereof.

The spherical and/or spheroidal sintered cemented carbide pellets and optional hard particles are dispersed in matrix metal or matrix alloy of the cladding. Any matrix metal or matrix alloy consistent with the objectives of provide claddings with desirable properties can be employed. In some embodiments, matrix alloy is nickel-based alloy. Nickel-based matrix alloy, for example, can have composition selected from Table III.

TABLE III
Nickel-based matrix alloys

| Element | Amount (wt. %) |
|---|---|
| Chromium | 0-30 |
| Molybdenum | 0-28 |
| Tungsten | 0-15 |
| Niobium | 0-6 |
| Tantalum | 0-6 |
| Titanium | 0-6 |
| Iron | 0-30 |
| Cobalt | 0-15 |
| Copper | 0-50 |
| Carbon | 0-2 |
| Manganese | 0-2 |
| Silicon | 0-10 |
| Phosphorus | 0-10 |
| Sulfur | 0-0.1 |
| Aluminum | 0-1 |
| Boron | 0-5 |
| Nickel | Balance |

In some embodiments, nickel-based matrix alloy of the cladding comprises 18-23 wt. % chromium, 5-11 wt. % molybdenum, 2-5 wt. % total of niobium and tantalum, 0-5 wt. % iron, 0.1-5 wt. % boron and the balance nickel. Alternatively, nickel-based matrix alloy of the cladding comprises 12-20 wt. % chromium, 5-11 wt. % iron, 0.5-2 wt. % manganese, 0-2 wt. % silicon, 0-1 wt. % copper, 0-2 wt. % carbon, 0.1-5 wt. % boron and the balance nickel. Further, nickel-based matrix alloy of the cladding can comprise 3-27 wt. % chromium, 0-10 wt. % silicon, 0-10 wt. % phosphorus, 0-10 wt. % iron, 0-2 wt. % carbon, 0-5 wt. % boron and the balance nickel. Nickel-based matrix alloy may also have a composition selected from Table IV.

TABLE IV
Nickel-based matrix alloys

| Ni-Based | Compositional |
|---|---|
| Alloy | Parameters (wt. %) |
| 1 | Ni—(13.5-16)%Cr—(2-5)%B—(0-0.1)%C |
| 2 | Ni—(13-15)%Cr—(3-6)%Si—(3-6)%Fe—(2-4)%B—C |
| 3 | Ni—(3-6)%Si—(2-5)%B—C |
| 4 | Ni—(13-15)%Cr—(9-11)%P—C |
| 5 | Ni—(23-27)%Cr—(9-11)%P |
| 6 | Ni—(17-21)%Cr—(9-11)%Si—C |
| 7 | Ni—(20-24)%Cr—(5-7.5)%Si—(3-6)%P |
| 8 | Ni—(13-17)%Cr—(6-10)%Si |
| 9 | Ni—(15-19)%Cr—(7-11)%Si—)—(0.05-0.2)%B |
| 10 | Ni—(5-9)%Cr—(4-6)%P—(46-54)%Cu |
| 11 | Ni—(4-6)%Cr—(62-68)%Cu—(2.5-4.5)%P |
| 12 | Ni—(13-15)%Cr—(2.75-3.5)%B—(4.5-5.0)%Si— |
| | (4.5-5.0)%Fe—(0.6-0.9)%C |
| 13 | Ni—(18.6-19.5)%Cr—(9.7-10.5)%Si |
| 14 | Ni—(8-10)%Cr—(1.5-2.5)%B—(3-4)%Si—(2-3)%Fe |
| 15 | Ni—(5.5-8.5)%Cr—(2.5-3.5)%B—(4-5)%Si—(2.5-4)%Fe |

Matrix alloy of the cladding can be cobalt-based alloy, in some embodiments. Cobalt-based alloy, for example, can have composition selected from Table V.

TABLE V
Cobalt-based alloys

| Element | Amount (wt. %) |
|---|---|
| Chromium | 5-35 |
| Tungsten | 0-35 |
| Molybdenum | 0-35 |
| Nickel | 0-20 |
| Iron | 0-25 |
| Manganese | 0-2 |
| Silicon | 0-5 |
| Vanadium | 0-5 |
| Carbon | 0-4 |
| Boron | 0-5 |
| Cobalt | Balance |

In some embodiments, cobalt-based matrix alloy of the cladding has composition selected form Table VI.

TABLE VI
Sintered Co-Based Alloy Cladding

| | Compositional |
|---|---|
| Co-Based | Parameters |
| Alloy | (wt. %) |
| 1 | Co—(15-35)%Cr—(0-35)%W—(0- |
| | 20)%Mo—(0-20)%Ni—(0- |
| | 25)%Fe—(0-2)%Mn—(0-5)%Si—(0- |
| | 5)%V—(0-4)%C—(0-5)%B |
| 2 | Co—(20-35)%Cr—(0-10)%W—(0- |
| | 10)%Mo—(0-2)%Ni—(0-2)%Fe—(0-2)%Mn—(0- |
| | 5)%Si—(0-2)%V—(0-0.4)%C—(0-5)%B |
| 3 | Co—(5-20)%Cr—(0-2)%W—(10- |
| | 35)%Mo—(0-20)%Ni—(0- |
| | 5)%Fe—(0-2)%Mn—(0-5)%Si—(0- |
| | 5)%V—(0-0.3)%C—(0-5)%B |
| 4 | Co—(15-35)%Cr—(0-35)%W—(0- |
| | 20)%Mo—(0-20)%Ni—(0- |
| | 25)%Fe—(0-1.5)%Mn—(0-2)%Si—(0- |
| | 5)%V—(0-3.5)%C—(0-1)%B |
| 5 | Co—(20-3 5)%Cr—(0-10)%W—(0- |
| | 10)%Mo—(0-1.5)%Ni—(0- |
| | 1.5)%Fe—(0-1.5)%Mn—(0-1.5)%Si—(0- |
| | 1)%V—(0-0.35)%C—(0-0.5)%B |
| 6 | Co—(5-20)%Cr—(0-1)%W—(10-35)%Mo—(0- |
| | 20)%Ni—(0-5)%Fe—(0-1)%Mn—(0.5-5)%Si—(0- |
| | 1)%V—(0-0.2)%C—(0-1)%B |

Matrix alloy of the cladding, in another aspect, can be iron-based alloy. Iron-based alloy, in some embodiments, comprises 0.2-6 wt. % carbon, 0-5 wt. % chromium, 0-37 wt. % manganese, 0-16 wt. % molybdenum and the balance iron. In some embodiments, iron-based alloy cladding has a composition according to Table VII.

TABLE VII
Iron-based infiltration alloy

| Fe-Based Alloy | Compositional Parameters (wt. %) |
|---|---|
| 1 | Fe—(2-6)%C |
| 2 | Fe—(2-6)%C—(0-5)%Cr—(28-37)%Mn |
| 3 | Fe—(2-6)%C—(0.1-5)%Cr |
| 4 | Fe—(2-6)%C—(0-37)%Mn—(8-16)%Mo |

The matrix alloy can provide the balance of the cladding when combined with the spherical and/or spheroidal sintered cemented carbide pellets and optional hard particles.

Claddings applied to metallic substrates by methods described herein can have any desired thickness. In some embodiments, a cladding applied to a metallic substrate has a thickness according to Table VIII.

TABLE VIII
Cladding Thickness

| | |
|---|---|
| >50 | μm |
| >100 | μm |

100 μm-20 mm
500 μm-5 mm

Claddings having architecture, composition, and/or properties described herein can exhibit desirable properties including enhanced thermal conductivity, transverse rupture strength, fracture toughness, wear resistance and/or erosion resistance. A cladding comprising spherical and/or spheroidal sintered cemented carbide particles, for example, can exhibit a thermal conductivity of at least. 25 W/(m·K) at 25° C. In some embodiments, the cladding has a thermal conductivity of at least 30 W/(m·K) or at least 35 W/(m·K) at 25° C. The spherical and/or spheroidal morphology of the sintered cemented carbide pellets significantly enhances thermal conductivity of the cladding. Table IX provides thermal conductivities of claddings fabricated according to methods described in Section III below, employing spherical and/or spheroidal sintered tungsten carbide pellets. Thermal conductivities of comparative claddings comprising angular and/or faceted sintered cemented carbide particles are also provided in Table IX.

TABLE IX
Cladding Thermal Conductivity W/(m · k)

| Wt. % Sintered Caribe | Angular | | Spheroid | |
|---|---|---|---|---|
| Pellets in Cladding | 25° C. | 100° C. | 25° C. | 100° C. |
| 65 | 20.5 | 16.1 | 36.0 | 38.1 |
| 55 | 20.2 | 14.4 | 29.4 | 29.9 |
| 50 | 16.6 | 14.3 | 25.6 | 27.9 |

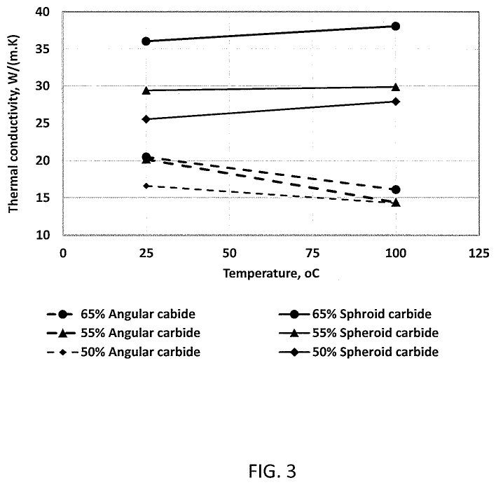

FIG. 3 further illustrates the thermal conductivity disparities between prior claddings employing angular sintered carbides and the claddings of the present disclosure comprising spherical and/or spheroidal sintered cemented carbide pellets.

Claddings described herein can also exhibit a fracture toughness (K_{Ic}) greater than 12 MPa·m^{0.5} or greater than 13 MPa·m^{0.5} when the sintered cemented carbide pellets are present in an amount of at least 55 weight percent of the cladding. In some embodiments, fracture toughness of the cladding is at least 15 MPa·m^{0.5} at a 55 weight percent loading of the spherical and/or spheroidal sintered cemented carbide pellets. Table X provides comparative fracture toughness data of claddings described herein with prior claddings employing angular sintered carbides, according to some embodiments.

TABLE X
Cladding Fracture Toughness (MPa · m^{0.5})

| Wt. % Sintered Caribe | | |
|---|---|---|
| Pellets in Cladding | Angular | Spheroid |
| 65 | 10.05 | 13.23 |
| 55 | 13.00 | 17.44 |

As provided in Table X, claddings described herein comprising spherical and/or spheroidal sintered cemented carbide pellets exhibited dramatic increases in fracture toughness. Fracture toughness values of claddings were determined according to a modified method based on ASTM E399 as set forth in Deng et al., Toughness Measurement of Cemented Carbides with Chevron-Notched Three-Point Bend Test, Advanced Engineering Materials, 2010, 12, No. 9.

Claddings described herein can also exhibit a transverse rupture strength of at least 650 MPa when the sintered cemented carbide pellets are present in an amount of at least 55 weight percent of the cladding. In some embodiments, transverse rupture strength of the cladding is at least 750 MPa at a 55 weight percent loading or greater of the spherical and/or spheroidal sintered cemented carbide particles. Table XI provides comparative transverse rupture strength data of claddings described herein with prior claddings employing angular sintered carbides, according to some embodiments.

TABLE XI
Cladding Transverse Rupture Strength (MPa)

| Wt. % Sintered Caribe | | |
|---|---|---|
| Pellets in Cladding | Angular | Spheroid |
| 65 | 562 | 665 |
| 55 | 660 | 788 |
| 50 | 763 | 843 |

As provided in Table XI, claddings described herein comprising spherical and/or spheroidal sintered cemented carbide pellets exhibited significant increases in transverse rupture strength. Transverse rupture strength values of claddings were determined according to ASTM B406 (2015).

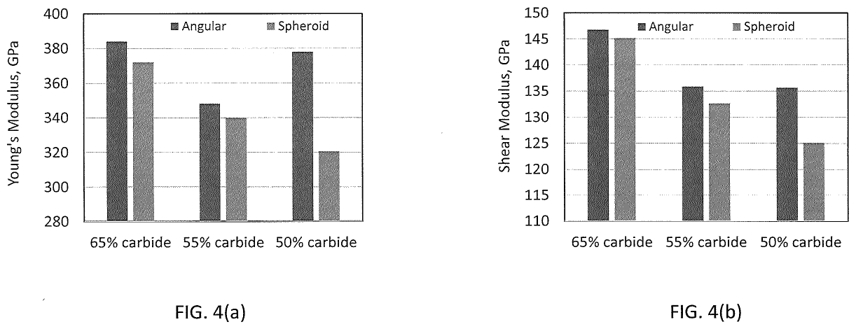

It has also been found that claddings described herein comprising sintered cemented carbide pellets having a spherical shape and/or spheroidal shape can exhibit reductions to Young's modulus and shear modulus relative to prior claddings comprising angular and/or faceted sintered cemented carbide particles. Reductions in Young's modulus, for example, can permit the cladding to better match the Young's modulus of the metallic substrate, thereby reducing the likelihood of cladding cracking and improving adhesion of the cladding. In some embodiments, for example, a cladding comprising spherical and/or spheroidal sintered cemented carbide pellets has a Young's modulus 30-65 percent greater than Young's modulus of the metallic substrate. FIG. 4(a) provides comparative Young's modulus data of claddings described herein with prior claddings employing angular sintered carbides. Similarly, FIG. 4(b) provides comparative shear modulus data of claddings described herein with prior claddings employing angular sintered carbides. Claddings comprising the spherical and/or spheroidal sintered cemented carbide particles display notable reductions in Young's modulus and shear modulus, permitting the cladding to more closely match the properties of the metallic substrate.

Importantly, the enhanced properties of thermal conductivity, fracture toughness, transverse rupture strength, Young's modulus and shear modulus offered by claddings described herein do not compromise abrasion resistance and erosion resistance of the claddings. In some embodiments, claddings having architecture, composition and/or properties described herein display average volume loss (AVL) less than 12 mm³ according to ASTM G65 Standard Test Method for Measuring Abrasion using the Dry Sand/Rubber Wheel, Procedure A. In some embodiments, the AVL is less than 10 mm³. Table XII provides comparative AVL data of claddings described herein with prior claddings employing angular sintered carbides, according to some embodiments.

TABLE XII
Cladding Abrasion Resistance (ASTM G65, Procedure A)

| Wt. % Sintered Caribe | Angular | Spheroid |
|---|---|---|
| Pellets in Cladding | (AVL - mm³) | (AVL - mm³) |
| 65 | 7.54 | 7.34 |
| 55 | 11.52 | 9.81 |
| 50 | 14.88 | 11.74 |

As provided in Table XII, claddings described herein comprising spherical and/or spheroidal sintered cemented carbide pellets exhibit better or comparable abrasion resistances.

Moreover, in some embodiments, claddings having architecture, composition and/or properties described herein display an erosion rate of less than 0.05 mm³/g at a particle impingement angle of 90° according to ASTM G76-07—Standard Test Method for Conducting Erosion Tests by Solid Particle Impingement Using Gas Jets. Table XIII provides comparative volume loss data of claddings described herein with prior claddings employing angular sintered carbides, according to some embodiments.

TABLE XII
Cladding Erosion Resistance (ASTM G76, volume loss, mm³)

| Wt. % Sintered Caribe | | |
|---|---|---|
| Pellets in Cladding | Angular | Spheroid |
| 65 | 0.025 | 0.026 |
| 55 | 0.031 | 0.031 |

As provided in Table XII, claddings described herein comprising spherical and/or spheroidal sintered cemented carbide pellets exhibit comparable erosion resistances.

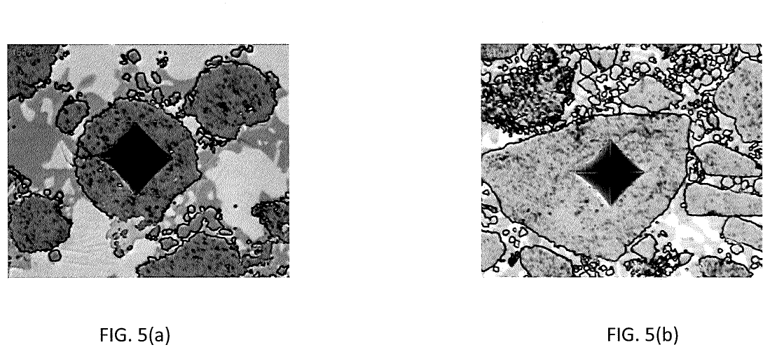

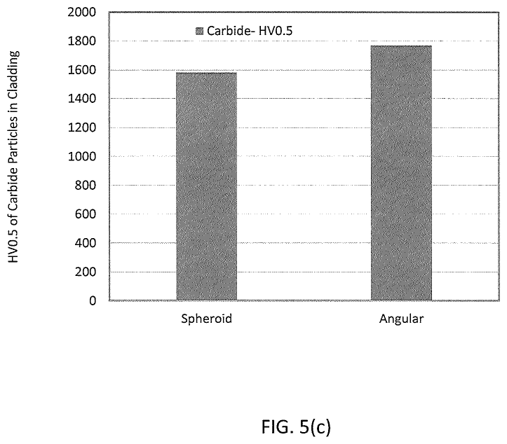

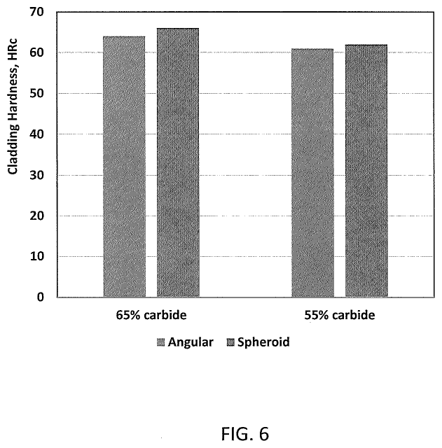

It was additionally found that spherical and/or spheroidal sintered cemented carbide particles can have hardness less than angular and/or faceted sintered cemented carbide pellets or particles. FIG. 5(a) is an image illustrating microhardness testing (HV0.5) of a spheroidal sintered cemented carbide pellet of a cladding herein. Similarly, FIG. 5(b) is an image of microhardness testing (HV0.5) of an angular sintered cemented carbide pellet of a prior cladding architecture. FIG. 5(c) illustrates the microhardness testing results wherein the angular sintered cemented carbide exhibits higher hardness. Notably, the lower hardness of the spheroidal sintered cemented carbide did not compromise cladding hardness. FIG. 6 illustrates hardness of claddings described herein comprising spherical and/or spheroidal sintered cemented carbide particles relative to prior claddings comprising angular sintered cemented carbide particles, according to some embodiments. As illustrated in FIG. 6, claddings described herein exhibited greater or comparable hardness (HRC).

Accordingly, it has been surprisingly found that including spherical and/or spheroidal sintered cemented carbide particles in matrix metal or matrix alloy of a cladding can enhance one or more of thermal conductivity, transverse rupture strength, and fracture toughness without concomitant compromises or reductions in abrasion resistance, erosion resistance, and/or hardness.

Moreover, claddings having composition, architecture and/or properties described herein generally have less than 5 vol. % porosity. In some embodiments, the claddings have less than 2 vol. % or less than 1 vol. % porosity.

As described herein, the claddings are adhered to metallic substrates. In being adhered to the metallic substrates, claddings described herein can be metallurgically bonded to the metallic substrates, in some embodiments. Suitable metallic substrates include metal or alloy substrates. A metallic substrate, for example, can be an iron-based alloy, nickel-based alloy, cobalt-based alloy, copper-based alloy or other alloy. In some embodiments, nickel alloy substrates are commercially available under the INCONEL®, HASTELLOY® and/or BALCO® trade designations. Cobalt alloy substrates, in some embodiments, are commercially available under the trade designation STELLITE®, TRIBALOY® and/or MEGALLIUM®. In some embodiments, substrates comprise cast iron, low-carbon steels, alloy steels, tool steels or stainless steels. A substrate can also comprise a refractory alloy material, such as tungsten-based alloys, molybdenum-based alloys or chromium-based alloys.

Moreover, substrates can have various geometries. In some embodiments, a substrate has a cylindrical geometry, wherein the inner diameter (ID) surface, outer diameter (OD) surface or both are coated with a cladding described herein. In some embodiments, for example, substrates comprise wear pads, pelletizing dies, radial bearings, extruder barrels, extruder screws, flow control components, roller cone bits, fixed cutter bits, piping or tubes. The foregoing substrates can be used in oil well and/or gas drilling applications, petrochemical applications, power generation, food and pet food industrial applications as well as general engineering applications involving abrasion, erosion and/or other types of wear.

### II. Composite Articles

In another aspect, composite articles for producing claddings are described herein. In some embodiments, a composite article comprises a polymeric carrier, and sintered cemented carbide pellets dispersed in the polymeric carrier, the sintered cemented carbide pellets having an apparent density of 4 g/cm³ to 7.5 g/cm³, wherein the composite article has a density of 7.0-10 g/cm³. In some embodiments, the sintered cemented carbide pellets have a tap density of 6.5 g/cm³ to 9 g/cm³. Sintered cemented carbide pellets dispersed in the polymeric carrier can have any composition and/or properties described in Section I hereinabove. In some embodiments, for example, the sintered cemented carbide pellets have a spherical shape, spheroidal shape, or a mixture of spherical and spheroidal shapes. Moreover, the sintered cemented carbide pellets can be present in the polymeric carrier in any amount consistent with producing a cladding having a pellet loading selected from Table II herein.

In some embodiments, the composite article further comprises powder metal or powder alloy dispersed in the polymeric carrier. Powder alloy in the polymeric carrier can have any composition described in Section I above, including any alloy composition set forth in Tables III-VII herein. In some embodiments, the polymeric carrier is fibrillated, such as fibrillated fluoropolymer. The fibrillated morphology of the polymeric carrier can provide the carrier and resultant composite article flexibility and other cloth-like characteristics. Such characteristics enable the composite article to be applied to a variety of complex surfaces including OD and ID surfaces of metallic substrates.

The polymeric carrier, sintered cemented carbide pellets, and optional powder alloy are mechanically worked or processed to trap the sintered pellets and powder alloy in the organic carrier. In one embodiment, for example, the sintered cemented carbide pellets and powder alloy are mixed with 3-15% PTFE by volume and mechanically worked to fibrillate the PTFE and trap the sintered pellets and alloy. Mechanical working can include rolling, ball milling, stretching, elongating, spreading or combinations thereof. In some embodiments, the sheet comprising the sintered pellets and powder alloy is subjected to cold isostatic pressing. The resulting sheet can have a low elastic modulus and high green strength. In some embodiments, a sheet comprising the sintered cemented carbide pellets and option powder alloy is produced in accordance with the disclosure of one or more of U.S. Pat. Nos. 3,743,556, 3,864,124, 3,916,506, 4,194,040 and 5,352,526, each of which is incorporated herein by reference in its entirety.

### III. Methods of Cladding Articles

In a further aspect, methods of making cladded articles are provided. A method of making a cladded article comprises providing a metallic substrate and positioning a layer of sintered cemented carbide pellets dispersed in organic carrier over the metallic substrate, the sintered cemented carbide pellets having a spherical shape, spheroidal shape, or a mixture of spherical and spheroidal shapes. Matrix metal or matrix alloy is also positioned over the metallic substrate. In some embodiments, matrix metal or matrix alloy is dispersed in the organic carrier with the sintered cemented carbide pellets. Alternatively, the matrix metal or matrix alloy is dispersed in a separate organic carrier or is provided as a foil. The matrix metal or matrix alloy is heated to infiltrate the layer of sintered cemented carbide pellets providing a composite cladding adhered to the substrate. In some embodiments, organic carrier of the sintered cemented carbide pellets and/or matrix metal or matrix alloy is a polymeric carrier as described in Section II above. Alternatively, the organic carrier may be a liquid or paint, such as the carrier compositions described in U.S. Pat. Nos. 6,649,682 and 7,262,240 each of which is incorporated herein by reference in its entirety.

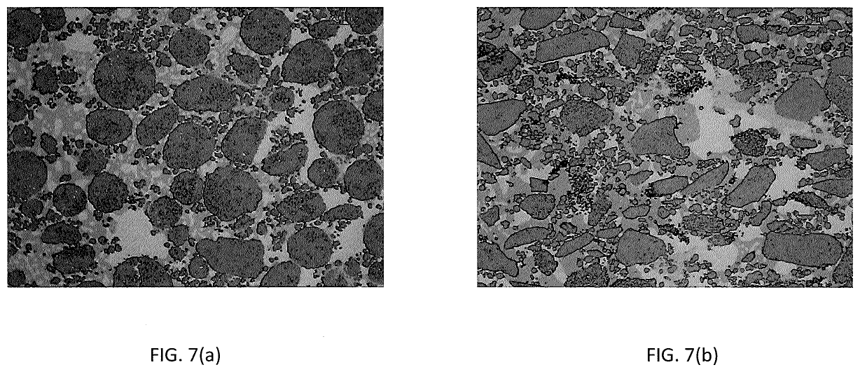

Claddings produced according to methods described herein can have any composition, architecture and/or properties described in Section I hereinabove. FIG. 7(a) is an optical micrograph of a cladding described herein comprising spherical and/or spheroidal sintered cemented carbide pellets according to some embodiments. The spherical and/or spheroidal sintered cemented carbide pellets of FIG. 7(a) are dispersed in matrix alloy. The spherical and/or spheroidal pellets of claddings of the present disclosure are in sharp contrast to angular and/or faceted sintered cemented carbide particles/pellets used in prior claddings, as illustrated in FIG. 7(b). As described above, the spherical and/or spheroidal sintered cemented carbide particles can unexpectedly enhance one or more of thermal conductivity, transverse rupture strength, and fracture toughness without concomitant compromises or reductions in abrasion resistance, erosion resistance, and/or hardness.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. An article comprising:
a metallic substrate; and
a cladding adhered to the metallic substrate, the cladding comprising at least 10 weight percent of sintered cemented carbide pellets dispersed in matrix metal or matrix alloy, the sintered cemented carbide pellets having a spherical shape, spheroidal shape, or a mixture of spherical and spheroidal shapes.

2. The article of claim 1, wherein the sintered cemented carbide pellets have an aspect ratio of 0.5 to 1.

3. The article of claim 1, wherein the sintered cemented carbide pellets are present in an amount of 40-70 weight percent of the cladding.

4. The article of claim 1, wherein one or more of the sintered cemented carbide pellets comprise metallic binder in an amount of 3 to 20 weight percent of the pellet.

5. The article of claim 1, wherein the sintered cemented carbide pellets are at least 98 percent theoretical density.

6. The article of claim 1, wherein the sintered cemented carbide pellets have an average size of 10 μm to 100 μm.

7. The article of claim 1, wherein one or more of the sintered cemented carbide pellets comprises metal carbide grains having size less than 3 μm.

8. The article of claim 1, wherein the cladding has thermal conductivity of at least 25 W/(m·K) at 25° C.

9. The article of claim 1, wherein the cladding has a fracture toughness (K_{Ic}) greater than 13 MPa·m^{0.5} when the sintered cemented carbide pellets are present in an amount of at least 55 weight percent of the cladding.

10. The article of claim 9, wherein the fracture toughness is greater than 15 MPa·m^{0.5}.

11. The article of claim 1, wherein the cladding has a transverse rupture strength of at least 650 MPa when the sintered cemented carbide pellets are present in an amount of at least 55 weight percent of the cladding.

12. The article of claim 1, wherein the cladding has a Young's modulus 30-65 percent greater than Young's modulus of the metallic substrate.

13. The article of claim 1, wherein greater than 50 percent of the sintered cemented carbide particles have size less than 45 μm.

14. The article of claim 1, wherein the cladding has less than 2 vol. % porosity.

15. A composite article comprising:
a polymeric carrier; and
sintered cemented carbide pellets dispersed in the polymeric carrier, the sintered cemented carbide pellets having an apparent density of 4 g/cm³ to 7.5 g/cm³, wherein the composite article has a density of 7.0-10 g/cm³.

16. The composite article of claim 15, wherein the polymeric carrier is fibrillated.

17. The composite article of claim 15, wherein the sintered cemented carbide pellets have a tap density of 6.5 g/cm³ to 9 g/cm³.

18. The composite article of claim 15, wherein the sintered cemented carbide pellets have a spherical shape, spheroidal shape, or a mixture of spherical and spheroidal shapes.

19. The composite article of claim 15, wherein the sintered cemented carbide pellets have an average size of 10 μm to 100 μm.

20. The composite article of claim 15, wherein greater than 50 percent of the sintered cemented carbide particles have size less than 45 μm.

21. The composite article of claim 15 further comprising powder metal or powder alloy dispersed in the polymeric carrier.

22. The composite article of claim 15, wherein one or more of the sintered cemented carbide pellets comprises metal carbide grains having size less than 1 μm.

23. A method of making a cladded article comprising
providing a metallic substrate;
positioning a layer of sintered cemented carbide pellets dispersed in organic carrier over the metallic substrate, the sintered cemented carbide pellets having a spherical shape, spheroidal shape, or a mixture of spherical and spheroidal shapes;
positioning matrix metal or matrix alloy over the metallic substrate; and
heating the matrix metal or matrix alloy to infiltrate the layer of sintered cemented carbide pellets providing a composite cladding adhered to the substrate.

24. The method of claim 23, wherein the organic carrier comprises a polymeric material.

25. The method of claim 23, wherein the organic carrier comprises a liquid component.

26. The method of claim 23, wherein the sintered cemented carbide pellets are present in an amount of 40-70 weight percent of the cladding.

27. The method of claim 23, wherein the sintered cemented carbide pellets are at least 98 percent theoretical density.

28. The method of claim 23, wherein the cladding has thermal conductivity of at least 25 W/(m·K) at 25° C.

29. The method of claim 23, wherein the cladding has a fracture toughness (K_{Ic}) greater than 12 MPa·m^{0.5} when the sintered cemented carbide pellets are present in an amount of at least 55 weight percent of the cladding.

30. The method of claim 23, wherein the fracture toughness is greater than 15 MPa·m^{0.5}.

31. The method of claim 23, wherein the cladding has a Young's modulus 30-65 percent greater than Young's modulus of the metallic substrate.
